(19) United States
(12) Patent Application Publication
(10) Pub. No.: US 2014/0279787 A1
(43) Pub. Date: Sep. 18, 2014

(54) Systems And Methods for an Adaptive Application Recommender

(71) Applicant: XIMPLAR LIMITED, Hong Kong SAR (HK)

(72) Inventors: Ka Kui Cheng, Hong Kong SAR (HK); Pui Tong Paul Lee, Hong Kong SAR (HK)

(73) Assignee: Ximplar Limited, Hong Kong SAR (HK)

(21) Appl. No.: 13/836,588

(22) Filed: Mar. 15, 2013

(51) Int. Cl. G06N 5/02

(52) U.S. Cl. CPC G06N 5/02
USPC 706/46

(57) ABSTRACT

With the growing number of downloaded applications on devices, especially on ones with limited screen real estate, users need a quick and pain-free way to locate applications. In accordance with one or more embodiments of the present invention, a system and methods are provided for generating an application selection recommendation.

### TECHNICAL FIELD

Embodiments of the invention are directed, in general, to recommender and, more specifically, to an adaptive application recommender.

### BACKGROUND

Mobile devices have changed the way people think of what an application is and the usage of it. In the past, getting a local weather forecast involved launching a web browser on a computer, entering a web address to a weather station, entering a zip code, and hitting an enter key to pull up the local weather forecast. With the availability of mobile applications, locate and launch is all it takes.

Seeing the potential in applications on mobile platforms, developers are releasing more applications than ever, with services covering almost every aspect of life. Users, liking the variety of options provided and the conveniency offered by each application, are downloading more applications than ever, pushing the application-download rate to an all-time high. And with the advancements in technology, the issues with running out of on-device storage space or significantly slowing down a device are no longer hindrances to a user when it comes to downloading applications.

With the increasing number of downloaded applications on device, searching for a specific application may become somewhat of a challenge. Flipping left and right or scrolling up and down becomes unavoidable. The time it takes to locate a specific application may very well rely on how applications are ordered and organized on the device. To combat the potential problem, some users may choose to manually place various applications on specific pages. This may work if there exist only a handful of applications. Any manual process involving a user is time consuming. The user has to account for scenarios like newly downloaded applications, opening slots from deleting existing applications. Some users may rely on the on-device operating system. Operating system may arrange applications by timestamp, by alphabetic order, by various grouping techniques, or by various usage based algorithms. This may work if the user is not too overly concerned with individualized user experience; does not mind a constantly evolving application layout or listing; does not mind the addition time needed to locate for an application, for example, if there are a 100 plus applications on a device and the applications are arranged alphabetically, additional time would definitely be needed when locating for an application that begins with the letter “Z”; does not mind performing some manual grouping tasks; or does not mind the additional time needed to locate an application within nested groupings or multiple groupings.

### SUMMARY

With the growing number of downloaded applications on devices, especially on ones with limited screen real estate, users need a quick and pain-free way to locate applications. In accordance with one or more embodiments of the present invention, a system and methods are provided for generating an application selection recommendation.

In one embodiment, the method may be performed by a processing device. The processing device may be configured to gather behavioral data resulting from a user's interaction with an application. The processing device may also be configured to analyze the behavioral data to identify a usage pattern in response to a predetermined selection factor. Also, the processing device may be configured to provide an application selection recommendation to the user in response to the usage pattern and a real time selection factor.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram illustrating one embodiment of a system for generating an application selection recommendation.

FIG. 2 is a schematic block diagram illustrating one embodiment of an apparatus for generating an application selection recommendation.

FIG. 3 is a schematic block diagram illustrating one embodiment of a computer system that may be adapted for use with embodiments of an adaptive application recommender.

FIG. 4A is a schematic flowchart diagram illustrating one embodiment of a method for generating an application selection recommendation.

FIG. 4B is a schematic flow chart diagram illustrating one embodiment of a method for gathering behavioral data in accordance with the present embodiments.

FIG. 5 is a schematic block diagram illustrating one embodiment of a predetermined selection factor for use with the present embodiments.

FIG. 6 is a schematic flowchart diagram illustrating one embodiment of a method for generating a usage pattern in accordance with the present embodiments.

FIG. 6A is a schematic flowchart diagram illustrating one embodiment of a method for generating a usage pattern in accordance with the present embodiments and one embodiment of a predetermined selection factor.

FIG. 6B is a schematic flowchart diagram illustrating another embodiment of a method for generating a usage pattern in accordance with the present embodiments and one embodiment of a predetermined selection factor.

FIG. 6C is a schematic flowchart diagram illustrating a further embodiment of a method for generating a usage pattern in accordance with the present embodiments and one embodiment of a predetermined selection factor.

FIG. 7 is a schematic block diagram illustrating one embodiment of a real time selection factor for use with the present embodiments.

FIG. 8 is a schematic flowchart diagram illustrating one embodiment of a method for generating an application selection recommendation in accordance with the present embodiments.

FIG. 9 is an exemplary data structure that may be maintained and used by one embodiment of an apparatus for generating an application selection recommendation.

FIG. 10 is an exemplary data set associated with a person X that may be maintained and used by one embodiment of an apparatus for an adaptive application recommender.

FIG. 11 is an exemplary data structure that may be maintained and used by one embodiment of an apparatus for an adaptive application recommender.

FIG. 12 is an exemplary data set associated with a person X that may be maintained and used by one embodiment of an apparatus for an adaptive application recommender.

FIG. 13 is a schematic flowchart diagram illustrating one embodiment of a method for gathering behavioral data in accordance with the present embodiments.

FIG. 14 is a schematic flowchart diagram illustrating one embodiment of a method for gathering behavioral data in accordance with the present embodiments.

FIG. 15 is a screen shot diagram illustrating one embodiment of a user interface of an apparatus for an adaptive application recommender.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

FIG. 1 illustrates one embodiment of the system 100 for providing an application selection recommendation. In one embodiment, the system 100 may include a network 102. One or more devices may be coupled to the network 102. In one embodiment, the device may be an application-enabled device. For example, an application-enabled device may include a mobile device 106, a desktop computer 108, a laptop computer 110, or smart television (“TV”) 112. In another embodiment, the system 100 may further include a server 104 coupled to the network 102. In a further embodiment, the system 100 may include a data repository 116 coupled to the network 102. In yet another embodiment, the system 100 may include a data repository 116 coupled to the server 104. For example, a data repository 116 may include a storage area network (SAN), a network attached storage (NAS), a direct attached storage (DAS), or a cloud storage. In an alternative embodiment, the system 100 may include a storage controller 114 or storage server configured to manage data communications between the data repository 116 and the server 104 or other components in communications with the network 102.

In one embodiment, the application-enabled device may be configured to perform operations for gathering data and generating recommendation. In an alternative embodiment, the application-enabled device may be configured to gather data from a user and send the data to the server 104 via the network 102. The server 104 may be configured to receive the data from the application-enabled device via the network 102, process the data, and send the processed data to the application-enabled device via the network 102. The application-enabled device may be configured to receive the processed data from the server 104 via the network, capture a selection factor 702 in real time, and generate application selection recommendation in response to the processed data and the selection factor 702.

In a further embodiment, the application-enabled device may be configured to gather data from a user and send the data to the server 104 via the network 102. The server 104 may be configured to receive the data from the application-enabled device via the network 102. The application-enabled device may also be configured to capture a selection factor 702 in real time and send the selection factor 702 to the server 104 via the network 102. The server 104 may be configured to receive the selection factor 702 from the application-enabled device, process the previously sent data from the application-enabled device, and generate an application selection recommendation in response to the selection factor 702 and the processed data. Lastly, the server 104 may be configured to send the application selection recommendation to the application-enabled device. The application-enabled device may be configured to receive the application selection recommendation from the server 104 via the network 102 and display the application selection recommendation to the user.

In another embodiment, the application-enabled device may be configured to gather data and a selection factor 702 from a user, process the data, and send the processed data and the selection factor 702 to the data repository 116 via the network 102. The server 104 may be configured to retrieve the processed data and the selection factor 702 from the data repository 116 via the network 102 and generate an application selection recommendation before sending the application selection recommendation to the application-enabled device. The application-enabled device may be configured to receive the application selection recommendation from the server 104 via the network 102 and display the application selection recommendation to the user. One of ordinary skilled in the art would recognize that the above is a non-limiting example and is for illustrating purpose and alternative embodiments and examples may exist.

FIG. 2 illustrates one embodiment of an apparatus 200 for providing an application selection recommendation. In one embodiment, the apparatus 200 may include a data gathering unit 202 and a data storage 206. The data gathering unit 202 may be configured to collect data from a user during use of the apparatus 200. The data gathered may include behavioral data. In another embodiment, the data gathered may include a selection factor 702. The data storage 206 may be configured to store any data. In one embodiment, the data stored may be from a data gathering unit 202. In another embodiment, the data stored may be from a data analyzer 204. In a further embodiment, the data stored may be from a selection recommender 208.

In an alternative embodiment, the apparatus 200 may further include a data analyzer 204. The data analyzer 204 may be configured to examine data gathered by the data gathering unit 202. In another embodiment, the data analyzer 204 may be configured to discover relationship between the data gathered by the data gathering unit 202 and a predetermined selected factor 502. In an alternative embodiment, the data analyzer 204 may be configured to generate usage pattern. Yet, in another embodiment, the apparatus 200 may include a selection recommender 208. The selection recommender 208 may be configured to generate application selection recommendation. In a further embodiment, the selection recommender 208 may also be configured to gather a selection factor 702. The present embodiments are not limiting the interactions between and/or among various system components of the apparatus 200. Rather the apparatus 200 is provided as an example of one type of interaction that may be adapted to perform the operations.

FIG. 3 illustrates a computer system 300 adapted for use with embodiments of an adaptive application selection recommender. The central processing unit (CPU) 302 is coupled to the system bus 304. The CPU 302 may be a general purpose CPU or microprocessor. The present embodiments are not restricted by the architecture of the CPU 302 as long as the CPU 302 supports the modules and operations as described herein. The CPU 302 may execute the various logical instructions according to the present embodiments. For example, the CPU 302 may execute machine-level instructions according to the exemplary operations described below with reference to FIG. 4.

The computer system 300 also may include Random Access Memory (RAM) 308, which may be SRAM, DRAM, SDRAM, or the like. The computer system 300 may utilize RAM 308 to store the various data structure used by a software application configured to generate an adaptive application selection recommendation. The computer system 300 may also include Read Only Memory (ROM) 306 which may be PROM, EPROM, EEPROM, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to locate and launch an application or select a real time selection factor 702 or application selection recommendation. In a further embodiment, the display adapter 322 may display a graphical user interface associated with a software application for presenting application selection recommendation.

The I/O adapter 310 may connect to one or more storage devices 312, such as one or more of a hard drive, a Compact Disk (CD) drive, a floppy disk drive, a tape drive, to the computer system 300. The communication adapter 314 may be adapted to couple the computer system 300 to the network 102, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the operations. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

FIG. 4A illustrates one embodiment of a method 400 for providing an application selection recommendation. In the illustrated embodiment, the method 400 starts with the data gathering unit 202 gathering 402 behavioral data. In one embodiment, the behavioral data may include data in response to a user's interaction with an application during use of the apparatus 200. In another embodiment, the behavioral data may include temporal data associated with the application in which the user interacts during use of the apparatus 200. In a further embodiment, the behavioral data may also include locality data associated with the application in which the user interacts during use of the apparatus 200. In an alternative embodiment, the behavioral data may include a history of application launches in which the user has interacted with during use of the apparatus 200. The data analyzer 204 analyzes 404 the behavior data gathered by the data gathering unit 202 and identifies a usage pattern in response to a predetermined selection factor 502. The selection recommender 208 provides 406 an application selection recommendation to the user in response to the usage pattern generated by the data analyzer 204 and a real time selection factor 702 obtained by the data gathering unit 202. In an alternative embodiment, the selection recommender 208 gathers a real time selection factor 702 prior to provide 406 an application selection recommendation to the user in response to the usage pattern generated by the data analyzer 204 and the real time selection factor 702.

FIG. 4B illustrates one embodiment of a method 402 for gathering behavioral data. In the illustrated embodiment, the method 402 starts with the data gathering unit 202 monitoring 408 for an application request. When launching an application based on the application request is detected, the data gathering unit 202 extracts 410 an application identifier from the application request, determines 412 the temporal data associated with the application identifier, and determines 414 the locality data associated with the application identifier.

FIG. 5 illustrates one embodiment of a predetermined selection factor 500. The predetermined selection factor 502 may influence the number and/or the type of usage patterns the data analyzer 204 may generate. The predetermined selection factor 502 may be an application based selection factor 504, a location based selection factor 506, or a time based selection factor 508. One of ordinary skilled in the art would recognize that a variety of predetermined selection factors 502 may be used in accordance with the present embodiments to achieve the function described above.

FIG. 6 illustrates one embodiment of a method 600 for generating a usage pattern in accordance with the present embodiments. In the illustrated embodiment, the method 600 starts with the data analyzer 204 determining 602 a type of predetermined selection factor 502 that may be used to generate a usage pattern. The predetermined selection factor 502 may be of type application based, time based, or location based. When the type selected is of application based, the data analyzer 204 sets 604 the application based selection factor 504 as the predetermined selection factor 502 and generates 606 the usage pattern in response to the application based selection factor 504. When the type selected is of location based, the data analyzer 204 sets 608 the location based selection factor 506 as the predetermined selection factor 502 and generates 610 the usage pattern in response to the location based selection factor 504. When the type selected is of time based, the data analyzer 204 sets 612 the time based selection factor 506 as the predetermined selection factor 502 and generates 614 the usage pattern in response to the time based selection factor 504. In another embodiment, the data analyzer 204 may be configured to perform the method 600 multiple times until a usage pattern for each of a plurality of predetermined based selection factors 502 is generated.

FIG. 6A illustrates one embodiment of a method 606 for generating a usage pattern in accordance with one embodiment of a predetermined selection factor 502. In the illustrated embodiment, the method 606 starts by determining 616 the method for use in generating a usage pattern in response to the application based section factor 504, availability of various types of behavioral data, and possibly time constraint. When behavioral data gathered by the data gathering unit 202 does not included a history of application launches and time constraint is not set by the data analyzer 204, the data analyzer 204 determines 618 a history of application launches from the behavioral data provided by the data gathering unit 202, discovers 620 the relationship between applications as suggested by the history of application launches, calculates 622 a frequency of occurrence of each of the discovered relationships, and generates 606 a usage pattern in response to the listed criteria. When behavioral data gathered by the data gathering unit 202 does not included a history of application launches and time constraint is set by the data analyzer 204, the data analyzer 204 correlates 624 the behavioral data by the application based selection factor 504, calculates 626 a frequency of occurrence of each of the discovered relationships, and generates 606 a usage pattern in response to the listed criteria. When behavioral data gathered by the data gathering unit 202 includes a history of application launches, the data analyzer 204 calculates 628 a frequency of occurrence of each of the correlated data and generates 606 a usage pattern in response to the listed criteria.

FIG. 6B illustrates one embodiment of a method 610 for generating a usage pattern in accordance with one embodiment of a predetermined selection factor 502. In the illustrated embodiment, the method 610 begins with the data analyzer 204 correlating 630 the behavioral data by the location based selection factor 506 and calculating 632 a frequency of occurrence of each of the correlated data before generating 610 a usage pattern in response to the listed criteria.

FIG. 6C illustrates one embodiment of a method 614 for generating a usage pattern in accordance with one embodiment of a predetermined selection factor 502. In the illustrated embodiment, the method 614 begins with the data analyzer 204 determining 634 a range of timeslots before correlating 636 the behavioral data by the time based selection factor 508. After the behavioral data has been correlated, the data analyzer 204 calculates 638 a frequency of occurrence of each of the correlated data and generates 614 a usage pattern in response to the listed criteria.

FIG. 7 illustrates one embodiment of a real time selection factor 700. The real time selection factor 702 may be gathered by the data gathering unit 202. In another embodiment, the real time selection factor 702 may be gathered by the selection recommender 208. The real time selection factor 702 may influence the selection recommender 208 in the construction of the application selection recommendation. The level and/or depth of the influence may vary depending on the type and/or number of real time selection factors 702 being used by the selection recommender 208. The real time selection factor 702 may be an application in use 704, a time of day 706, a day of week 708, or a user's location during use 710. One of ordinary skilled in the art would recognize that a variety of real time selection factors 702 may be used in accordance with the present embodiments to achieve the function described above.

FIG. 8 illustrates one embodiment of a method 800 for generating an application selection recommendation in accordance with the present embodiments. In the illustrated embodiment, the method 800 starts with the selection recommender 208 determining 802 the number and 804 the type of real time selection factors 702 for use in generating an application selection recommendation. In an alternative embodiment, the data gathering unit 202 may be configured to detect 802 the number and 804 the type of real time selection factors 702 from a user of the apparatus 200. The number of real time selection factors 702 may be of one or more. The real time selection factor 702 may be of type application, time, day, or location. When the number of real time selection factor 702 selected is of one and the type of real time selection factor 702 selected is of application, the selection recommender 208 sets 806 the application in use as the real time selection factor 702. When the number of real time selection factor 702 selected is of one and the type of real time selection factor 702 selected is of time, the selection recommender 208 sets 808 the time of the day as the real time selection factor 702. When the number of real time selection factor 702 selected is of one and the type of real time selection factor 702 selected is of day, the selection recommender 208 sets 810 the day of week as the real time selection factor 702. When the number of real time selection factor 702 selected is of one and the type of real time selection factor 702 selected is of location, the selection recommender 208 sets 812 the user's location during use as the real time selection factor 702. One of ordinary skilled in the art would recognize that a variety of real time selection factors 702 may be used in accordance with the present embodiments.

Once the real time selection factor 702 is set, the selection recommender 208 queries 814 from a usage pattern generated by the data analyzer 206 the availability of an application in response to the real time selection factor 702. In certain embodiment, the selection recommender 208 may be configured to query 814 a usage pattern repeatedly until all applications in response to the real time selection factor are found 816. Then, the selection recommender 208 calculates 820 a launch probability for each of the found applications, ranks 826 the applications in response to their associated launch probabilities, and presents 840 the ranked applications as application selection recommendation.

In another embodiment, the selection recommender 208 detects 802 the number of real time selection factors 702 selected is greater than one, gathers 822 a plurality of real time selection factor types 702 from a user of the apparatus 200, and sets 824 the real time selection factors accordingly. In an alternative embodiment, the data gathering unit 202 may be configured to detect 802 the number of real time selection factors selected and gather 822 a plurality of real time selection factor types 702 from a user of the apparatus 200. The selection recommender 208 then sets 824 the real time selection factors 702 gathered by the data gathering unit 202 accordingly. The selection recommender 208 queries 814 from a usage pattern generated by the data analyzer 206 the availability of an application in response to the real time selection factor 702. In certain embodiment, the selection recommender 208 may be configured to query 814 a usage pattern repeatedly until all applications in response to the real time selection factor 702 are found 816. The selection recommender 208 then determines 818 if queries in response to a plurality of real time selection factors 702 are completed before calculating 820 a launch probability for each of the plurality of applications in response to each of the plurality of real time selection factors 702 and ranks 826 the applications in response to their associated launch probabilities in response to each of the plurality of real time selection factors 702. Since there exists 828 more than one set of rankings, the selection recommender 208 first determines 830 a weight for each of the plurality of real time selection factors 702, then calculates 832 a weighted launch probability for each of the plurality of applications in response to each of the plurality of real time selection factors 702, before aggregating 834 the weighted launch probability for each of the plurality of applications in response to each of the plurality of real time selection factors 702. Once the aggregation of weighted launch probabilities is completed, the selection recommender 208 ranks 836 the plurality of applications in response to their associated weighted launch probabilities and presents 838 the weighted ranked applications as application selection recommendation to the user.

FIG. 9 illustrates an exemplary data structure 900 with field names and their associated data types that may be maintained and used by one of the embodiments of the apparatus 200 for generating an application selection recommendation. In the illustrated example, the data structure includes four fields: application launch request identification (ID) of data type long; application launch request of type string; application launch location of type string; and application launch timestamp of type timestamp.

FIG. 10 illustrates an exemplary data set 1000 associated with a person X that may be maintained and used by one embodiment of an apparatus for generating an application selection recommendation. The data gathering unit 202 starts with monitoring 408 for an application request. When the user selects an application, the data gathering unit 202 extracts 410 an application identifier from the application request and writes the application identifier to the application launch request field. The data gathering unit 202 also gathers a launching time and a launching location before writing the launching time of the application to the application launch timestamp field and the launching location of the application to the application launch location field.

FIG. 11 illustrates an exemplary data structure 1100 with field names and their associated data types that may be maintained and used by one of the embodiments of the apparatus 200 for generating an application selection recommendation. In the illustrated example, the data structure includes four fields: sequence identification (ID) of data type long; application launch request from of type string; application launch request to of type string; and frequency of type long.

FIG. 12 illustrates an exemplary data set 1200 associated with a person X that may be maintained and used by one embodiment of an apparatus for generating an application selection recommendation. The data analyzer 204 determines 618 a history of application launches from the behavioral data provided by the data gathering unit 202; discovers 620 the relationship between applications as suggested by the history of application launches; and calculates 622 a frequency of occurrence of each of the discovered relationships. When the calculation is completed, the data analyzer 204 writes each discovered relationship into the application launch request from field and application launch request to field and the frequency of occurrence of each discovered relationship to the frequency field.

FIG. 13 through 15 describe a specific embodiment of the method 800 generally outlined in FIG. 8. One of ordinary skilled in the art would recognize that this is a non-limiting example and is for illustrating purpose and alternative embodiments and examples may exist. FIG. 13 illustrates one embodiment of a method 1300 for gathering behavioral data. A user, sitting in a café restaurant at 12 noon on a Friday, wishes to browse the Internet on the apparatus 200. She locates and launches 1302 a web browser application and browses 1304 the Internet via the web browser application. The data-gathering unit 200 detects an application launch request, extracts 410 an application identifier “web browser” from the application launch request, and writes the phrase “web browser” to the application launch request field; gathers the launching time of the web browser application and writes the timestamp “12 noon on a Friday” to the application launch time stamp field; and gathers the launch location of the web browser application and writes “at cafe” to the application launch location field. While browsing the Internet via the web browser application, she encounters 1306 difficulties in understanding certain words in one of the webpages. She locates and launches 1308 a dictionary application and looks 1310 up the words in the dictionary application. The data-gathering unit 200 detects an application launch request, extracts 410 an application identifier “dictionary” from the application launch request, and writes the phrase “dictionary” to the application launch request field; gathers the launching time of the dictionary application and writes the timestamp “12:30 pm on a Friday” to the application launch time stamp field; and gathers the launch location of the dictionary application and writes “at cafe” to the application launch location field. She continues 1304 with browsing the Internet via the web browser application after having looked up the definitions.

FIG. 14 illustrates one embodiment of a method 1400 for gathering behavioral data. A user, sitting in a café restaurant at 1 pm on a Friday, wishes to play a word game with her friends on the apparatus 200. She locates and launches 1402 a word game application and plays 1404 a round of word game with one of her friends. The data-gathering unit 200 detects an application launch request, extracts 410 an application identifier “word game” from the application launch request, and writes the phrase “word game” to the application launch request field; gathers the launching time of the word game application and writes the timestamp “1 pm on a Friday” to the application launch time stamp field; and gathers the launch location of the word game application and writes “at cafe” to the application launch location field. She encounters 1406 difficulty in understanding a word that her friend has put down. She locates and launches 1408 a dictionary application and looks 1410 up the word in the dictionary application. The data-gathering unit 200 detects an application launch request, extracts 410 an application identifier “dictionary” from the application launch request, and writes the phrase “dictionary” to the application launch request field; gathers the launching time of the dictionary application and writes the timestamp “1 pm on a Friday” to the application launch time stamp field; and gathers the launch location of the dictionary application and writes “at cafe” to the application launch location field. She continues 1404 to play with her friend after having looked up the word.

The data analyzer 204 determines 618 a history of application launches from the behavioral data provided by the data gathering unit 202. The history of application launches in the illustrated example is web browser application to dictionary application to web browser application to word game application to dictionary application to word game application. The data analyzer 204 discovers 620 the relationship between applications as suggested by the history of application launches. In the illustrated example, two relationships are discovered. The first discovered relationship is a link between a web browser application and a dictionary application. The second discovered relationship is a link between a dictionary application and a word game application. The data analyzer calculates 622 a frequency of occurrence of each of the discovered relationships. When the calculation is completed, the data analyzer 204 writes each discovered relationship into the application launch request from field and application launch request to field and the frequency of occurrence of each discovered relationship to the frequency field. In the illustrated example, the data analyzer 204 creates two records, one with “web browser” in the application launch request from field; “dictionary” in the application launch request to field; and three in the frequency field and another one with “word game” in the application launch request from field; “dictionary” in the application launch request to field; and two in the frequency field.

FIG. 15 illustrates one embodiment of a user interface 1500 of an apparatus 200 for an adaptive application recommender. In the illustrated embodiment, the user sits in a café restaurant using a dictionary application 1502 to look up a definition of a word “potion” on the apparatus 200. The selection recommender 208 sets 806 the dictionary application 1502 as the real time selection factor 702 and queries 814 from a usage pattern generated by the data analyzer 206 the availability of an application in response to the dictionary application 1502 as the real time selection factor 702. Two applications, namely web browser application 1506 and word game application 1508, are found and displayed as recommendations under the launcher interface 1504. When the user clicks on the launcher interface 1504 during use of the dictionary application 1502, two applications, web browser application 1506 and word game application 1508, are presented as recommendations. In the above description, application in use is being used as a specific example of real time selection factor 702 in the generation of the application selection recommendation. One of ordinary skilled in the art may recognize the other real time selection factors 702, such as location, or a combination of a plurality of real time selection factors 702, such as time and location, may be used in the generation of the application selection recommendation.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method comprising:
in a processing device:
gathering behavioral data resulting from a user's interaction with an application, wherein the behavioral data comprises temporal data associated with the application, and locality data associated with the application;
analyzing the behavioral data to identify a usage pattern in response to a predetermined selection factor; and
providing an application selection recommendation to the user in response to the usage pattern and a real time selection factor.

2. The method of claim 1, wherein the behavioral data further comprises:
a history of application launches.

3. The method of claim 1 further comprising:
storing the usage pattern.

4. The method of claim 1, wherein analyzing the behavioral data to identify the usage pattern in response to the predetermined selection factor further comprises:
analyzing the behavioral data to identify the usage pattern in response to an application based selection factor, wherein the usage pattern specifies a plurality of applications.

5. The method of claim 1, wherein analyzing the behavioral data to identify the usage pattern in response to the predetermined selection factor further comprises:
analyzing the behavioral data to identify the usage pattern in response to an location based selection factor, wherein the usage pattern specifies a plurality of applications clustered by a plurality of locations.

6. The method of claim 1, wherein analyzing the behavioral data to identify the usage pattern in response to the predetermined selection factor further comprises:
analyzing the behavioral data to identify the usage pattern in response to a time based selection factor, wherein the usage pattern specifies a plurality of applications clustered by a plurality of predetermined time slots.

7. The method of claim 1, wherein gathering the behavioral data resulting from the user's interaction with the application further comprises:
monitoring an application request;
extracting an application identifier from the application request;
determining temporal data associated with the application identifier;
determining locality data associated with the application identifier.

8. The method of claim 1, wherein the real time selection factor comprises:
an application in use.

9. The method of claim 1, wherein the real time selection factor comprises:
a location of the processing device during the user's interaction with the application.

10. The method of claim 1, wherein the real time selection factor comprises:
a time of day corresponding to the user's interaction with the application.

11. The method of claim 1, wherein the real time selection factor comprises:
a day of week corresponding to the user's interaction with the application.

12. The method of claim 1, wherein providing the application selection recommendation to the user in response to the usage pattern and the real time selection factor further comprises:
querying from the usage pattern an availability of an application in response to the real time selection factor;
acquiring the application from the usage pattern;
calculating a launch probability of the application in response to the real time selection factor and the usage pattern;
ranking the application in response to the launch probability of the application;
adding the application to the application selection recommendation;
receiving an application selection request; and
displaying the application as the application selection recommendation.

13. The method of claim 12, wherein the usage pattern is acquired from a cloud storage facility in response to the real time selection factor.

14. The method of claim 12, wherein a second usage pattern is acquired from a cloud storage facility in response to the real time selection factor, and wherein calculating the launch probability is performed in response to the real time selection factor, the usage pattern, and the second usage pattern.

15. The method of claim 12 further comprising:
assigning a weight to the real time selection factor;
calculating a weighted launch probability for the application in response to the weight and the launch probability of the application;
aggregating the weighted launch probability of the application; and
ranking the application in response to the weighted launch probability of the application.

16. The method of claim 3, wherein storing the usage pattern further comprises:
storing the usage pattern to a cloud storage facility.

17. The method of claim 16, wherein storing the usage pattern to the cloud storage facility further comprises:
saving the usage pattern to a local storage device;
queuing the usage pattern for copying to the cloud storage facility; and
communicating, through a network connection, the usage pattern from the local storage device to the cloud storage facility.

18. The method of claim 16 further comprising:
stripping personal data from the usage pattern.

19. A system comprising:
a processor;
a memory, coupled to the processor, containing a program, which when executed by the processor is configured to:
gather behavioral data resulting from a user's interaction with an application, wherein the behavioral data comprises temporal data associated with the application, and locality data associated with the application;
analyze the behavioral data to identify a usage pattern in response to a predetermined selection factor;
provide an application selection recommendation to the user in response to the usage pattern and a real time selection factor; and
a data storage configured to:
store the usage pattern.

20. The system of claim 19, wherein the memory is further configured to:
gather the behavioral data resulting from the user's interaction with the application, wherein the behavioral data comprises a history of application launches.

21. The system of claim 18 further comprising:
a network adaptor configured to:
store the usage pattern to a cloud storage facility.

22. A tangible non-transitory computer readable medium comprising computer readable code, that when executed by a processing device, cause the processing device to perform operations comprising:
gathering behavioral data resulting from a user's interaction with an application, wherein the behavioral data comprises temporal data associated with the application, and locality data associated with the application;
analyzing the behavioral data to identify a usage pattern in response to a predetermined selection factor;
storing the usage pattern; and
providing an application selection recommendation to the user in response to the usage pattern and a real time selection factor.
